(19) United States
(12) Patent Application Publication
(10) Pub. No.: US 2015/0046116 A1
(43) Pub. Date: Feb. 12, 2015

(54) Method and Apparatus for Monitoring Motion of a Body in a Selected Frame of Reference

(71) Applicant: Graham Paul Eatwell, Annapolis, MD (US)

(72) Inventor: Graham Paul Eatwell, Annapolis, MD (US)

(21) Appl. No.: 13/960,162

(22) Filed: Aug. 6, 2013

(51) Int. Cl. G01B 21/00; G01L 5/00; G01C 19/02; A42B 3/30; G01B 7/00

(52) U.S. Cl. CPC G01B 21/00; A42B 3/30; G01B 7/00; G01P 9/02; G01L 5/0052
USPC 702/150

(57) ABSTRACT

A method and apparatus for monitoring impacts on or between bodies is disclosed. In one application, head impacts and the performance of a helmet during impacts are monitored by determining head motion and helmet motion relative to a common origin and/or frame of reference in response to sensed head motion and sensed helmet motion. The head motion in the common frame of reference is compared with helmet motion in the common frame of reference to determine performance of the helmet. The apparatus may include a surface-mountable motion sensor having a reusable sensing circuit and a disposable mounting structure.

### PRIORITY CLAIM

This application claims priority from Provisional Application Ser. No. 61/519,354, filed May 20, 2011, titled “Method and Apparatus for Monitoring Rigid Body Motion in a Selected Frame of Reference”, which is hereby incorporated by reference herein, and application Ser. No. 13/506,766, filed May 16, 2012, titled “Method and Apparatus for Monitoring Motion of a Substantially Rigid Body in a Selected Frame of Reference”, which is hereby incorporated by reference herein.

### BACKGROUND

A variety of methods have been proposed to measure head impacts. One approach uses sensors in a helmet. This approach is flawed since the helmet may rotate on the head during an impact, or even become displaced.

Another approach uses tri-axial accelerometers embedded in patches attached to the head. This approach is has limited accuracy since the position and orientation of the patches on head is not known precisely.

Yet another approach uses a combination of a tri-axial linear accelerometer and a gyroscope. This approach yields rotations and linear acceleration at the sensor location. However, when the desire is to measure the motion of a rigid body, such as a human head, it is often impossible or impractical to place a sensor at the center of the rigid body.

A helmet is used to provide the head with a degree of protection from impacts. The performance of helmet is commonly assessed in the laboratory by subjecting an instrumented dummy head to known impacts. The linear and rotational acceleration of the dummy head is measured with and without the helmet to determine the degree of protection provided. However, in practice the degree of protection is dependent upon additional factors, such as how well the helmet fits the head, how the helmet is placed on the head, degradation of the helmet with use, the direction and intensity of the impact, etc. Accordingly, it would be useful to provide means for in-situ measurement of helmet performance. Such a means could also be used to simplify laboratory testing of helmets.

### BRIEF DESCRIPTION OF THE FIGURES

The accompanying figures, in which like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a diagrammatic representation of a system for monitoring acceleration of a rigid body, in accordance with certain embodiments of the present invention.

FIG. 2 is a block diagram of a system for monitoring rigid body motion using a single six degree-of-freedom sensor, in accordance with certain embodiments of the present invention.

FIG. 3 is a flow chart of a method for monitoring motion of a rigid body, using a six degree-of-freedom sensor, in accordance with certain embodiments of the present invention.

FIG. 4 is a block diagram of a system for monitoring rigid body motion using two six-degree-of-freedom sensors, in accordance with certain embodiments of the invention.

FIG. 5 is a flow chart of a method for monitoring rigid body motion using two six-degree-of-freedom sensors, in accordance with certain embodiments of the invention.

FIG. 6A, FIG. 6B, and FIG. 6C are views of an exemplary sensor, in accordance with certain embodiments of the invention.

FIG. 7 is a diagrammatic representation of a system for monitoring head motion, in accordance with certain embodiments of the invention.

FIG. 8 is a further diagrammatic representation of a system for monitoring head motion, in accordance with certain embodiments of the invention.

FIG. 9 is a flow chart of a method for monitoring rigid body motion using self-calibration, in accordance with certain embodiments of the invention.

FIG. 10 is a flow chart of a method for monitoring performance of a helmet or other impact protection device, in accordance with certain embodiments of the invention.

FIG. 11 is a diagrammatic representation of a sensor having a reusable sensing circuit and a disposable mounting structure, in accordance with certain embodiments of the invention.

FIG. 12 is a sectional view of sensor shown in FIG. 11, in accordance with certain embodiments of the invention.

FIGS. 13 and 14 are diagrammatic views of a sensor, in accordance with further embodiments of the invention.

FIGS. 15 and 16 are diagrammatic views of a sensor, in accordance with still further embodiments of the invention.

FIG. 17 is flow chart of a method for monitoring impacts between two or more bodies, in accordance with further embodiments of the invention.

FIG. 18A, FIG. 18B, and FIG. 18C, illustrate an exemplary method for determining relative positions of first and second bodies at a time of impact, in accordance with certain embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to monitoring motion of a substantially rigid body, such as a head, and monitoring performance of a protective body, such as a helmet. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

It will be appreciated that embodiments of the invention described herein may include the use of one or more conventional processors and unique stored program instructions that control the one or more processors to implement, in conjunction with certain non-processor circuits, some, most, or all of the functions of monitoring head and helmet accelerations described herein. The non-processor circuits may include, but are not limited to, a radio receiver, a radio transmitter, signal drivers, clock circuits, power source circuits, and user input devices. As such, these functions may be interpreted as a method to monitor head and helmet accelerations, or accelerations of other bodies. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

The present disclosure relates to a method and apparatus for monitoring motion of a rigid body, such as a human head or a helmet, relative to a first location. Linear and rotational motions are sensed by one or more sensors attached to the rigid body at locations displaced from the first location. The sensed rotation is used to compensate for the angular and centripetal acceleration components in the sensed linear motion. In one embodiment, the angular and centripetal acceleration components are estimated explicitly from the sensed rotation. In a further embodiment, the sensed rotations are used to estimate the relative orientations of two or more sensors, enabling the linear motions measured by the two sensors to be combined so as to cancel the angular and centripetal accelerations. Monitored head motion may be compared with monitored helmet motion to determine the performance of the helmet.

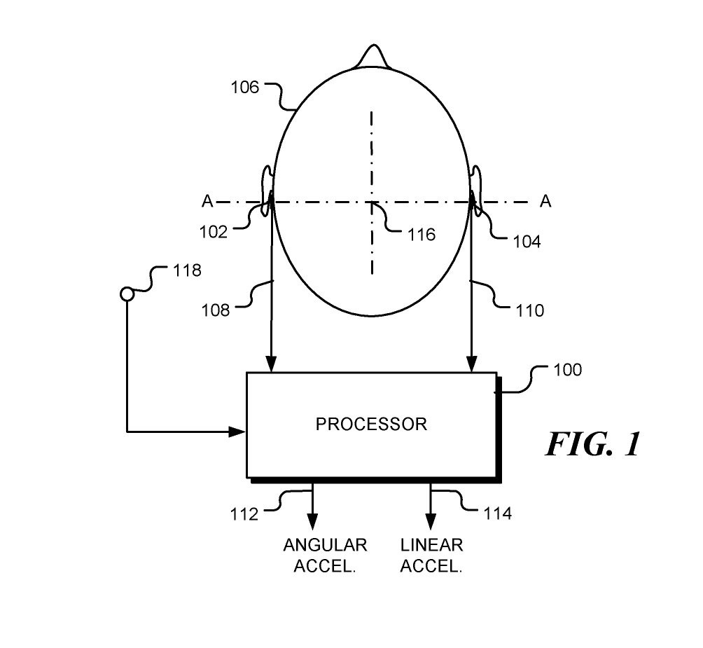

FIG. 1 is a diagrammatic representation of a system for monitoring acceleration of a substantially rigid body in accordance with certain embodiments of the present invention. The system comprises a processor 100 that receives signals from a first motion sensor 102. In some embodiments, the processor 100 also receives signals from a second motion sensor 104. The first and second motion sensors may be configured to measure both linear and rotational motions and may be six degree-of-freedom sensors. In operation, the first and second sensors 102 and 104 are located on a substantially rigid body 106, such as human head, and are coupled to the processor 100 via wired or wireless connections 108 and 110, respectively. The processor 100 may be integrated with one of the sensors, located in proximity to a sensor (such as attached to a helmet, mouth-guard, or belt pack), or placed at a location remote to the sensor. While shown diagrammatically as a head in FIG. 1, the present invention has application to other rigid bodies. For example, the rigid body could be a helmet, a handheld device, an instrument or tool, or a vehicle.

In one embodiment, a six degree-of-freedom sensor comprises a three-axis linear motion sensor, such as a tri-axial accelerometer that senses local linear motion, and a rotational sensor that measures three components of a rotational motion. The rotational sensor maybe, for example, a three-axis gyroscope that senses angular velocity, or a three-axis rotational accelerometer that senses the rate of change of angular velocity with time, or a three axis angular displacement sensors such as a compass, or a combination thereof. The six degree-of freedom sensor may comprise more than six sensing elements. For example, both rotational rate and rotational acceleration could be sensed (or even rotational position). These signals are not independent, since they are related through their time histories. However, having both types of sensors may avoid the need for integration or differentiation.

The processor 100 receives the sensor signals 108 and 110 and from them generates angular acceleration signals 112 and linear acceleration signals 114 in a frame of reference that does not have its origin at a sensor position and may not have its axes aligned with the axes of the sensor.

In one embodiment, which uses two sensors, the origin of the frame of reference is at a midpoint of the line A-A between the sensors 102 and 104, denoted in FIG. 1 by the point labeled 116.

In a further embodiment, which uses a single sensor, the origin may be selected to be any point whose position is known relative to the single sensor.

In the selected frame of reference, the vector of angular velocities of the substantially rigid body is denoted as ω, the angular acceleration vector is denoted as \dot{ω}), and the linear acceleration vector is denoted as a.

It is noted that the angular acceleration may be obtained from angular velocity by differentiation with respect to time and, conversely, the angular velocity may be obtained from the angular acceleration by integration with respect to time. These integrations or differentiations may be performed using an analog circuit, a sampled data circuit or by digital signal processing. Thus, either type of rotation sensor could be used. Alternatively, or in addition, a rotation displacement sensor, such as a magnetic field sensor, may be used. Angular velocity and angular acceleration may then be obtained by single and double differentiation, respectively.

The response s of a linear accelerometer at a position r={r₁,r₂,r₃}^{T} in the selected frame of reference is given by

s=sₗᵢₙ[a+(K(\dot{ω})+K²(ω))r]=Sₗᵢₙ[a−K(r)\dot{ω}+P(r)γ(ω)], (1)

where a is the linear acceleration vector at the origin of the frame of reference and γ(ω) is a vector of centripetal accelerations given by

$$γ ( ω ) = [ \begin{matrix}- {ω}_{1}^{2} - {ω}_{2}^{2} \\ - {ω}_{2}^{2} - {ω}_{3}^{2} \\ - {ω}_{3}^{2} - {ω}_{1}^{2} \\ {ω}_{1} {ω}_{2} \\ {ω}_{2} {ω}_{3} \\ {ω}_{3} {ω}_{1}\end{matrix} ] . \qquad ( 2 )$$

Sₗᵢₙ is the linear sensitivity matrix for the sensor (which is dependent upon the sensor orientation), the matrix function K is defined as the skew symmetric matrix given by

$$K ( r ) {=}^{Δ} [ \begin{matrix}0 & - {r}_{3} & {r}_{2} \\ {r}_{3} & 0 & - {r}_{1} \\ - {r}_{2} & {r}_{1} & 0\end{matrix} ] , \qquad ( 3 )$$

the matrix P is given by

$$P ( r ) {=}^{Δ} [ \begin{matrix}0 & {r}_{1} & 0 & {r}_{2} & 0 & {r}_{3} \\ 0 & 0 & {r}_{2} & {r}_{1} & {r}_{3} & 0 \\ {r}_{3} & 0 & 0 & 0 & {r}_{2} & {r}_{1}\end{matrix} ] \qquad ( 4 )$$

In general, for a rotational sensor, the response vector is

w=Sᵣₒₜ(ω,\dot{ω}) (5)

where Sᵣₒₜ is the angular sensitivity matrix of the sensor. From this we can get (using integration or differentiation as required)

ω=F(w)

\dot{ω}=G(w)′ (6)

where F and G are functions that depend upon the angular sensitivity matrix Sᵣₒₜ of the sensor.

In accordance with a first aspect of the disclosure, the linear acceleration at the origin of the frame of reference may be derived from the sensed linear and rotation motion.

Rearranging equation (1) gives

a=Sₗᵢₙ⁻¹s+K(r)\dot{ω}−P(r)γ(ω), (7)

and estimating the rotational components from the rotation sensor signal w gives

a=Sₗᵢₙ⁻¹s+K(r)G(w)−P(r)γ(F(w)), (8a)

or,

a=Sₗᵢₙ⁻¹s−[K(G(w))+K²(F(w))]r, (8b)

Thus, the linear acceleration at the origin is obtained as a combination of the linear motion s, and rotational motion w sensed at the sensor location, the combination being dependent upon the position r of the sensor relative to the origin and the linear sensitivity and orientation of the sensor through the matrix Sₗᵢₙ. The matrix parameters K (r) and P (r) used in the combination (8a) are dependent upon the position r.

For a rigid body, the rotational acceleration at the origin is the same as the rotational acceleration at the sensor location and is given by equation (6).

It is noted that the combination defined in equations (8a) and (8b) requires knowledge of the sensitivities of the sensor and knowledge of position of the sensor relative to the origin.

In equation (7), the matrix Sₗᵢₙ is dependent upon the orientation of the sensor relative to the frame of reference.

In one embodiment the sensor is oriented in a known way on the rigid body. This is facilitated by marking the sensor (for example with an arrow).

In a further embodiment, the sensor is shaped to facilitate consistent positioning and/orientation on the body. For example, a behind-the-ear sensor may be shaped to conform to the profile of an ear, or a nose sensor is shaped to conform to the bridge of the nose.

In a still further embodiment, a measurement of the sensor orientation relative to the direction of gravity is made and the frame of reference is fixed relative to the direction of gravity.

### Generic System

In a still further embodiment, measurement of the sensor orientation is made relative to a reference sensor, shown as 118 in FIG. 1, and the frame of reference is fixed relative to the reference sensor. The reference sensor 118 may be, for example, a three-axis linear accelerometer that measures the gravitation vector when there is no rotation present, or a three-axis rotation sensor, such as a gyroscope or rotational accelerometer, or a combination thereof. Multiple reference sensors may be used. Alignment is discussed in more detail below, with reference to equations (13)-(16). In one embodiment, in which the rigid body is a human head, the one or more reference sensors are attached with a known orientation, and at a known position, to a reference structure, such as helmet to be worn on the head or to a mouthpiece or mouthguard. For low acceleration movements, the reference structure moves with the head and provides consistent orientation with respect to the head. A sensor, such as a position, proximity, pressure or light sensor for example, may be used to detect when the reference structure is in position. This allows the sensor 102 to be placed on the head in any orientation. In general, the one or more reference sensors 118 may be attached to a reference structure that, at least at low acceleration levels, moves with the rigid body to be measured.

A sensor may be attached using self-adhesive tape, for example. The sensor should be as light as possible, so that the resonance frequency of the sensor mass on the compliance of the skin is as high as possible (see, for example, ‘A Triaxial Accelerometer and Portable Data Processing Unit for the Assessment of Daily Physical Activity’, Carlijn V. C. Bouten et al., IEEE TRANSACTIONS ON BIOMEDICAL ENGINEERING, VOL. 44, NO. 3, MARCH 1997, page 145, column 2, and references therein). A self-adhesive, battery powered sensor may be used, the battery being activated when the sensor is attached to the head.

The sensor 102 may be calibrated with respect to the reference sensor 118.

### Single Sensor

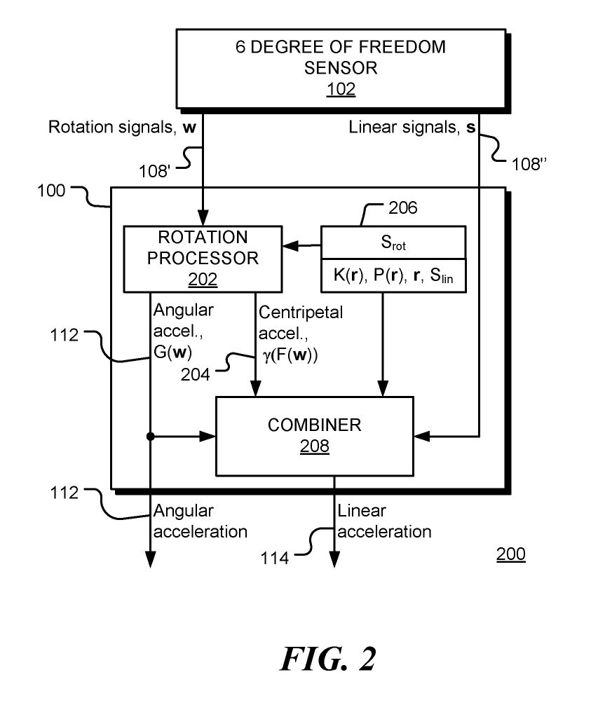

FIG. 2 is a block diagram of a system 200 for monitoring head motion, helmet motion, or other rigid body motion, using a single six degree-of-freedom sensor 102. The processor 100 receives rotational motion signals 108′, denoted as w, and linear motion signals 108″, denoted as s, from the six degree-of-freedom sensor 102. The rotational motion signals 108′ are processed in a rotation processor 202 to produce angular acceleration signals 112, denoted as \dot{ω}=G (w), and centripetal acceleration signals 204, denoted as γ(ω)=γ(F (w)) (defined in equation (2) above). Operation of the rotation processor 202 is dependent upon the sensor's rotational sensitivity matrix Sᵣₒₜ stored in a memory 206. The linear motion signals 108″, angular acceleration signals 112 and centripetal acceleration signals 204 are combined in combiner 208 in accordance with equation (8) above, using matrix coefficients stored in a memory 206, to produce the linear acceleration signals 114. The linear acceleration signals 114 are referenced to selected origin, rather than the sensor position. The matrix coefficients stored in the memory 206 are dependent upon the position of the sensor relative to the selected origin. The linear acceleration signals 114 are output from the system. Optionally, the rotational acceleration and/or centripetal acceleration may be output.

The system 200 enables monitoring motion of a substantially rigid body relative to a first location in response to linear 108″ and rotational motion signals 108′ from a motion sensor 102 locatable on the substantially rigid body at a second location, displaced from the first location. The system comprises a processing module 202 responsive to the rotational motion signal 108′ and operable to produce a plurality of rotational components, 112 and 204. A memory 206 stores parameters dependent upon the first and second locations. A combiner 208 combines the plurality of rotational components with the linear motion signals 108″, dependent upon the parameters stored in the memory 206, to provide an estimate of the motion at the first location in the substantially rigid body. The signals 114 and/or 112, representative of the motion at the first location, are provided as outputs. The rotational components comprise first rotational components 112, dependent upon angular acceleration of the substantially rigid body and second rotational components 204 dependent upon angular velocity of the substantially rigid body.

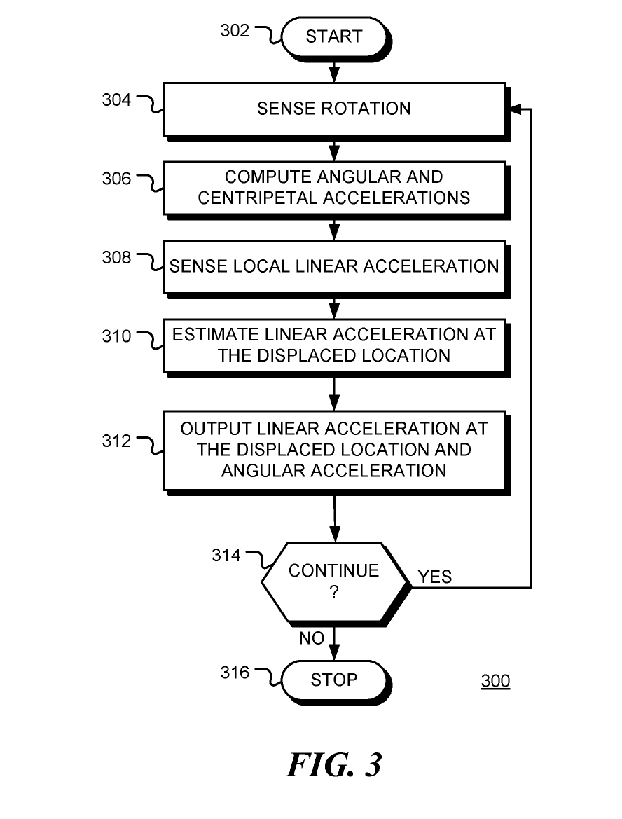

FIG. 3 is a flow chart 300 of a method for monitoring motion of a rigid body, such as a human head, using a six degree of freedom sensor. Following start block 302 in FIG. 3, rotation of the rigid body is sensed at block 304. At block 306, the angular and centripetal accelerations are computed from the sensed signals in accordance with equation (6) above. At block 308, the local linear accelerations (at the sensor position) are sensed. At block 310, the linear accelerations at another location, displaced from the sensor location are estimated by combining the local linear acceleration signals with the angular and centripetal acceleration signals in accordance with equation (8). At block 312, the signal representing the linear accelerations at the displaced location is output. The signals may be output via a wired or wireless connection to a remote location, a proximal location, or a local storage device. Optionally, the angular acceleration and/or centripetal accelerations may also be output. If, as depicted by the positive branch from decision block 314, continued monitoring of motion is required, flow returns to block 304. Otherwise, the method terminates at block 316.

The flow chart in FIG. 3 shows an illustrative embodiment of a method for monitoring motion of a substantially rigid body relative to a first location. The method comprises sensing a linear acceleration vector of the substantially rigid body at a second location, displaced from the first location, sensing a first rotation of the substantially rigid body, determining an angular acceleration component of the sensed linear acceleration vector from the sensed first rotation, determining a centripetal acceleration component of the sensed linear acceleration vector from the sensed first rotation, estimating the linear motion at the first location dependent upon a combination of the angular acceleration component, the centripetal acceleration component and the linear acceleration vector, and outputting a signal representative of the motion at the first location. The combination is dependent upon the relative positions of the first and second locations.

While the approach described above has the advantage of using a single sensor, one disadvantage is that, unless a reference sensor is used, the approach requires knowledge of position of the sensor relative to the origin. However, if a reference sensor is used, the position, orientation and sensitivity may be estimated.

### Two or More Sensors

In accordance with a second aspect of the present disclosure, the linear acceleration at the origin of the frame of reference may be derived from the sensed linear and rotation motion at two or more sensors. In one embodiment, two sensors are used, located on opposite sides of the desired monitoring position. For example, one sensor could be either side of a head to monitor motion relative to a location between the sensors. This approach avoids the need to know the sensor locations relative to the selected origin, and also avoids the need for differentiation or integration with respect to time, although more than one sensor is required.

To facilitate explanation, a two-sensor system is considered first. The first and second sensors are referred to as ‘left’ and ‘right’ sensors, however, it is to be understood that any pair of sensors may be used.

The origin is defined as the midpoint between the two sensors. Thus, the sensor positions are r_{L}={r₁,r₂,r₃}^{T} for the left sensor and r_{R}={−r₁,−r₂,−r₃}^{T} for the right sensor.

The accelerations are not necessarily the same, since, as discussed above, each measurement is in the frame of reference of the corresponding sensor. In the frame of reference of the left sensor,

S_{L,lin}⁻¹s_{L}=a+[K(\dot{ω})+K²(ω)]r_{L}, (9)

R⁻¹S_{R,lin}⁻¹s_{R}=a+[K(\dot{ω})+K²(ω)]r_{R}, (10)

where R is a rotation matrix that is determined by the relative orientations of the two sensors and the sensitivity matrices are relative to the sensor's own frame of reference. R⁻¹S_{R,lin}⁻¹s_{R} is a vector of compensated and aligned right sensor signals and S_{L,lin}⁻¹s_{L} is the vector of compensated left sensor signals.

Averaging (9) and (10) gives

$$\frac{1}{2} {S}_{L , lin}^{- 1} {s}_{L} + \frac{1}{2} {R}^{- 1} {S}_{R , lin}^{- 1} {s}_{R} = a + \frac{1}{2} [ K ( \dot{ω} ) + {K}^{2} ( ω ) ] ( {r}_{L} + {r}_{R} ) = a \qquad ( 11 )$$

where R is a rotation matrix that is determined by the relative orientations of the two sensors and the sensitivity matrices are relative to the sensor's own frame of reference. Here we have used r_{L}+r_{R}=0.

This allows the linear acceleration at the origin (the midpoint) to be estimated as the simple combination

$$a = \frac{1}{2} {S}_{L , lin}^{- 1} {s}_{L} + \frac{1}{2} {R}^{- 1} {S}_{R , lin}^{- 1} {s}_{R} . \qquad ( 12 )$$

In some applications, the left and right sensors may be orientated with sufficient accuracy that the rotation matrix can be assumed to be known. In other applications, the rotation matrix R may be estimated from a number of rotation measurements (rate or acceleration). The measurements may be collected as

W_{R}=RW_{L}, (13)

where W_{L} and W_{R} are signal matrices given by

W_{R}=[w_{R,1} w_{R,2} . . . w_{R,N}],

W_{L}=[w_{L,1} w_{L,2} . . . w_{L,N}]. (14)

This equation may be solved by any of a variety of techniques known to those of ordinary skill in the art. For example, an unconstrained least squares solution is given by

R=W_{R}W_{L}^{T}(W_{L}W_{L}^{T})⁻¹. (15)

The solution may be constrained such that R is a pure rotation matrix. Further, the equations may be extended to enable sensor offsets to be determined if desired.

Alternatively, the rotation matrix may be found from the rotational motion signals using an iterative algorithm, such as least mean square or recursive least mean square algorithm.

The relative orientation may also be obtained by comparing gravitation vectors and magnetic field vectors, provided that the body is not rotating or is rotating only slowly.

More generally, a weighted average of the aligned signals from two or more sensors (adjusted for orientation and sensitivity) may be used to estimate the linear acceleration at a position given by a corresponding weighted average of the sensor positions when the sum of the weights is equal to one. If a is the linear motion at the position

$$\overline{r} {=}^{Δ} {\sum }_{i} {α}_{i} {r}_{i} , with {\sum }_{i} {α}_{i} = 1 ,$$

the weighted average of aligned signals is

$$\begin{matrix}{\sum }_{i} {α}_{i} {R}_{i}^{T} {S}_{i}^{- 1} {s}_{i} = {\sum }_{i} {α}_{i} a + [ K ( \dot{ω} ) + {K}^{2} ( ω ) ] {\sum }_{i} {α}_{i} ( {r}_{i} - \overline{r} ) \\ = a + [ K ( \dot{ω} ) + {K}^{2} ( ω ) ] ( {\sum }_{i} {α}_{i} {r}_{i} - \overline{r} ) \\ = a ,\end{matrix} \qquad ( 16 )$$

where Rᵢ is the alignment matrix for sensor i, αᵢ are weights that sum to unity, and Sᵢ is a sensitivity matrix. The vector rᵢ− r̅ denotes the position vector from the position r̅ to sensor i.

Equation (16) is a generalization of equation (12) and describes operation of a system for monitoring motion of a substantially rigid body relative to a first location, r̅. In operation, a plurality of motion sensors are located on the substantially rigid body at a plurality of second locations, rᵢ, displaced from the first location r̅, each motion sensor (with index i) of the plurality of motion sensors operable to measure a motion vector sᵢ at a second location rᵢ of the plurality of second locations. A processing module includes an alignment estimator operable to produce an alignment matrix Rᵢ between each motion sensor of the plurality of motion sensors and a reference frame, dependent upon the motion vectors at the plurality of second locations. An alignment module aligns the motion vectors with the frame of reference, using the alignment matrix, to produce a plurality of aligned motion vectors, RᵢSᵢ⁻¹sᵢ. A combiner combines the plurality of aligned motion vectors to provide an estimate

$${\sum }_{i} {α}_{i} {R}_{i} {S}_{i}^{- 1} {s}_{i}$$

of the motion at the first location in the substantially rigid body. A signal representative of the motion of the substantially rigid body relative to the first location is output or saved n a memory.

The position vector r of the first location is a weighted average

$${\sum }_{i} {α}_{i} {r}_{i}$$

of the position vectors of the plurality of second locations and the estimate of the motion at the first location comprises a corresponding weighted average

$${\sum }_{i} {α}_{i} {R}_{i} {S}_{i}^{- 1} {s}_{i}$$

of the plurality of aligned motion vectors.

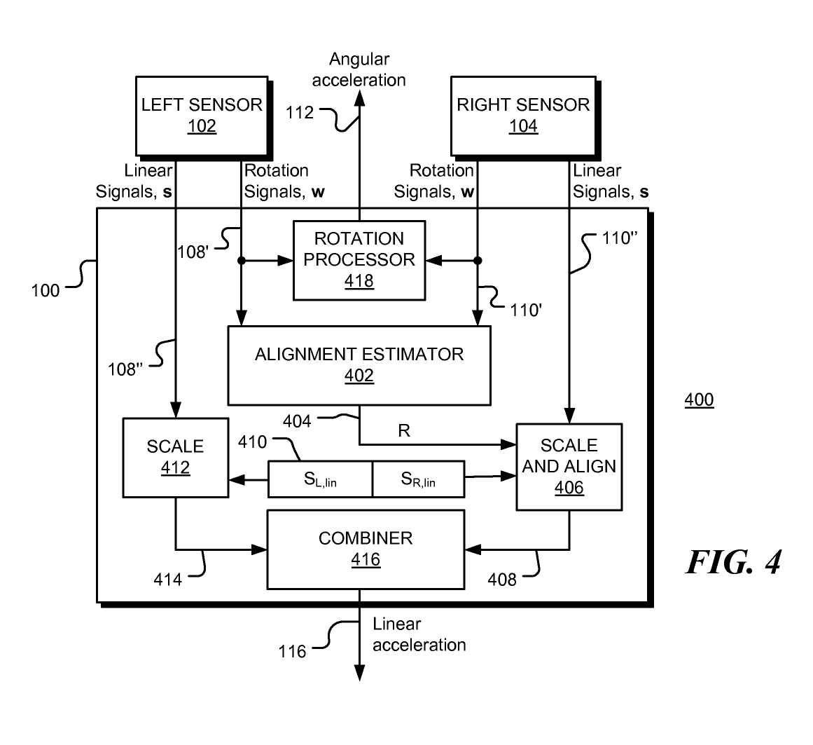

FIG. 4 is a block diagram of a system 400 for monitoring rigid body motion using two six degree-of-freedom sensors in accordance with certain embodiments of the disclosure. Referring to FIG. 4, a left sensor 102 provides rotational motion signals 108′ and linear motion signals 108″ to a processor 100 and a right sensor 104 provides rotational motion signals 110′ and linear motion signals 110″ to the processor 100. The rotational motion signals 108′ and 110′ are fed to alignment estimator 402. From these signals, the alignment estimator 402 determines a rotation matrix 404, denoted as R, which describes the relative orientations of the left and right sensors. The alignment estimator 402 solves equation (13). In one embodiment, it implements equation (15), or a similar algorithm, such as an iterative least squares algorithm, a constrained least squares algorithm or a singular value decomposition algorithm. A variety of such algorithms are known to those of ordinary skill in the art. The rotation matrix 404 is used in a scaling and alignment module 406 to compensate for the right sensor sensitivity and align the linear motion signals of the right sensor with the linear motion signals of the left sensor. The scaling and alignment module 406 produces compensated and aligned linear motion signals, R⁻¹S_{R,lin}⁻¹s_{R}, 408 from the right sensor as output. The scaling and alignment module 406 utilizes the linear sensitivity matrix S_{R,lin} of the left sensor, which is stored in a memory 410. Scaling module 412 scales the left sensor linear motion signals to compensate for the sensitivity of the left sensor, dependent upon the linear sensitivity matrix S_{L,lin} of the left sensor, and produces compensated left sensor linear motion signals, S_{L,lin}⁻¹s_{L}, 414. The compensated and aligned linear motion signals 408 from the right sensor are combined with the compensated linear motion signals 414 from the left sensor in combiner 416, in accordance with equation (12) or equation (16), to produce an estimate 116 of the linear acceleration at the origin (the midpoint). The estimate 116 of the linear acceleration at the origin is output for local storage or transmission to a remote location. Optionally, the rotational motion signals 108′ and 110′ are processed in rotation processor 418 to produce an estimate 112 of the angular acceleration. In one embodiment, the rotational motion signals are scaled dependent upon the rotational sensitivity matrices, S_{L,rot} and S_{R,rot}, aligned, and then averaged to produce the estimate 112. The signals are differentiated with respect to time if they correspond to angular velocity rather than angular acceleration.

Measurements of the motion at the two sensors may be synchronized by means of a synchronization signal, such as a clock with an encoded synchronization pulse. The clock may be generated by the processor 100 or by one of the sensors. When identical sensors are used, a ‘handshake’ procedure may be used to establish which sensor will operate at the master and which will operate as the slave. Such procedures are well known to those of ordinary skill in the art, particularly in the field of wired and wireless communications.

The signals 112 and 116 together describe the motion of the rigid body and may be used to determine, for example, the direction and strength of an impact to the body. This has application to the monitoring of head impacts to predict brain injury.

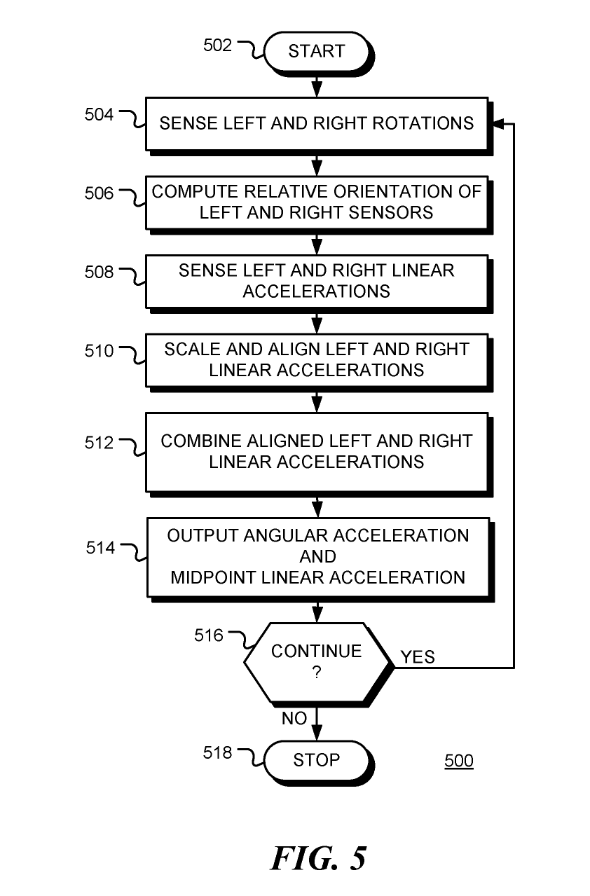

FIG. 5 is a flow chart 500 of method for monitoring rigid body motion using two six degree-of-freedom sensors in accordance with certain embodiments of the disclosure. Following start block 502 in FIG. 5, the rotational motions at the left and right sensors are sensed at block 504. The rotational motion signals are used, at block 506, to compute a rotation matrix that describes the relative orientations of the left and right sensors. At block 508, the left and right linear accelerations are sensed. At block 510, the sensed linear acceleration signals are scaled and aligned using the sensitivity matrices and the rotation matrix. The scaled and aligned linear acceleration signals are combined at block 512 to produce an estimate of the linear acceleration vector at the midpoint between the left and right sensors. At block 514, the estimate of the linear acceleration vector is output. Optionally, the angular acceleration vector is also output at block 514. If monitoring is to be continued, as depicted by the positive branch from decision block 516, flow returns either to block 504 to update the estimate of the relative orientations, or to block 508 to continue sensing the linear accelerations. Otherwise, as depicted by the negative branch from decision block 516, the process terminates at block 518.

In a still further embodiment, the alignment matrix R is found by comparing measurements of the gravity vector made at each sensor location. These measurements may be made by the linear elements of sensor or by integrated gravity sensors. In this embodiment one of the sensors does not require rotational sensing elements, although such elements may be included for convenience or to improve the accuracy of the rotation measurement.

In one embodiment the sensor is oriented in a known way on the rigid body. This is facilitated by marking the sensor (for example with an arrow).

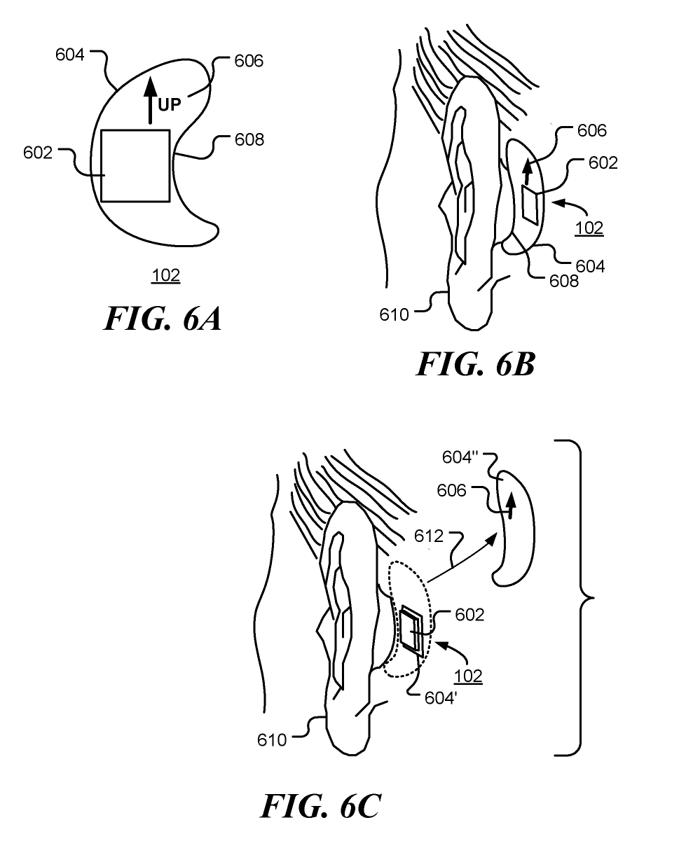

Consistent positioning and orientation of the sensors may be facilitated by shaping or marking the sensor. For example, a behind-the-ear sensor may be shaped to conform to the profile of the back of an ear, or a nose sensor shaped to conform to the bridge of the nose. FIG. 6A shows an exemplary sensor 102 adapted for positioning behind an ear. The sensor includes a sensing circuit 602, a patch or other mounting structure 604 for attaching the sensor to the head and a marker 606 for indicating the correct orientation. In this example, the marker comprises an arrow and lettering that indicate the UP direction. In the example shown, the edge 608 of the patch or mounting structure 604 has a concave edge shape to match the shape of the back of the ear 610.

FIG. 6B shows the sensor positioned behind an ear 610. In a further embodiment, the patch is configured for positioning behind either ear. A measurement of the direction of gravity may be used to determine if the sensor is on the left or right side of the head.

In one embodiment, a portion of the patch is configured to be removable once the sensor has been positioned on the patch. This part of patch may be considered to be a template that allows accurate and consistent positioning of the patch. This may be advantageous, for example, to prevent the edge 608 from moving against the back of the ear, which may cause irritation. FIG. 6C shows an embodiment where a first portion 604″ of the sensing structure is a template that is used to position the patch behind the ear. The template 604″ overlays the remainder of the patch sensor. After positioning, the template 604″ is removed, as indicated by the arrow 612, and the sensing circuit 602 is supported on the head via mounting structure 604′. The original position of the template 604″ is shown by the broken line. Thus, accurate positioning of the sensing circuit, both for location and orientation, is maintained with a lighter, more comfortable patch,

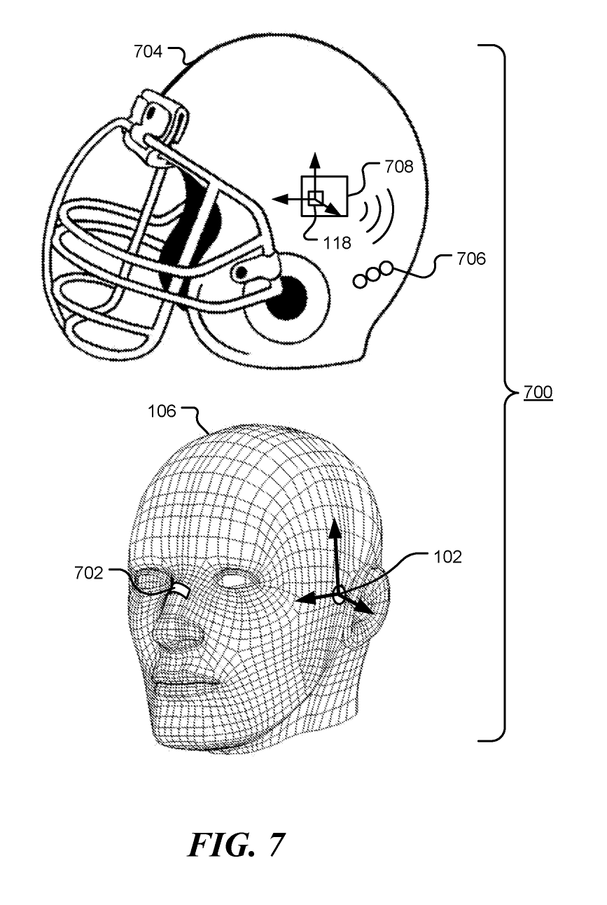

More generally, the sensor elements are coupled to a mounting structure shaped for consistent orientation with respect to a characteristic feature of a substantially rigid body, and outputs linear and rotational motion signals. In a further embodiment, the mounting structure comprises a flexible band, such as 702 shown in FIG. 7, for configured for alignment with the bridge of a nose. In one embodiment, a tri-axial accelerometer and tri-axial gyroscope are incorporated with the flexible band 702, together with a wireless telemetry system and a power source such as a battery or a circuit for remote power reception.

### Self-Calibration

In a further embodiment of the invention, the head mounted sensing system is calibrated relative to a reference sensing system on a helmet, mouthguard or other reference structure. The position of the helmet on a head is relatively consistent. The positioning of mouthguard, such as protective mouth guard is very consistent, especially if custom molded to the wearer's teeth. While both a helmet and a mouthguard can be dislodged following an impact, they move with the head for low level linear and rotational accelerations. The calibration is not simple, however, since there is a non-linear relationship between the sensor signals due to the presence of centripetal accelerations. The method has application to head motion monitoring, for sports players and military personnel for example, but also has other applications. For example, the relative positions and orientations of two rigid objects that are coupled together, at least for a while, may be determined from sensors on the two bodies.

Self-calibration avoids the need to position and orient a sensor accurately on the head and also avoids the need to pre-calibrate the head sensors for sensitivity. This reduces the cost of the head sensors. A unique identifier may be associated with each helmet or mouthguard. This avoids the need for have a unique identifier associated with each head sensor, again reducing cost. Also, signals transmitted to a remote location (such as the edge of a sports field) are more easily associated with an individual person whose head is being monitored. That is, the helmet or mouthguard may be registered as belonging to a particular person, rather than registering each head sensor. Additionally, the helmet or mouthguard sensor may be used as a backup should the head sensor fail and may also detect such failure. Still further, head motion and helmet motion may be compared to each other to monitor the performance of the helmet, that is, the effectiveness of the helmet in reducing head accelerations.

FIG. 7 is a diagrammatic representation of a system 700 for monitoring head motion in accordance with certain embodiments of the invention. The system 700 comprises a sensor 102, such as a six degree-of-freedom sensor, adapted to be attached to a head 106. The sensor 102 may be positioned at various places on the head, such as in front of an ear (as shown), behind an head, in the ear, or on the bridge of the noise in strip or band 702. One or more locations may be used.

The system 700 also comprises a reference sensor 118 of a reference sensing system 708 coupled to a helmet 704. The reference sensing system 708 may also include a processor, a transmitter and a receiver. A helmet 704 is shown in FIG. 7, but other reference structures, such as a mouthguard, may be used. The reference sensor 118 may comprise a rotational sensor such as a three-axis gyroscope or three-axis rotational accelerometer. The reference sensor may also include a three-axis linear accelerometer. The sensor is operable to establish a wireless connection to the processing module mounted in the helmet or at a remote location. The helmet may include a sensor to detect when the helmet 704 is in the correct position on the head 106.

In operation, the processing module operates to compute a rotation matrix R that describes the relative orientation of the head mounted sensor 102 relative to the helmet mounted sensor 118. The rotation matrix satisfies

W_{H}=S_{H,rot}RS_{R,rot}⁻¹W_{R}, (17)

where W_{L} and W_{R} are signal matrices given by

W_{R}=[ω_{R,1} ω_{R,2} . . . ω_{R,N}],

W_{H}=[ω_{H,1} ω_{H,2} . . . ω_{H,N}]. (18)

The subscript ‘R’ denotes the reference (helmet or mouthpiece, for example) sensor and the subscript ‘H’ denotes the head mounted sensor. Since the inverse sensitivity matrix S_{R,rot}⁻¹ of the reference sensor is known, equation (17) may be solved in the processing module for the matrix product S_{H,rot}R, the inverse of which is used to compute rotations relative to the frame of reference of the reference sensor. The matrix product may be estimated when the reference structure is first coupled to the head, or it may be continuously updated during operation whenever the rotations are below a threshold. Higher level rotations are not used, since they may cause the helmet to rotate relative to the head.

When a linear reference sensor is used, the gravitation vectors measured by the reference and head mounted sensors may be used to estimate the rotation matrix. The rotation matrix satisfies

G_{H}=S_{H,lin}RS_{R,lin}⁻¹G_{R}, (19)

where G_{L} and G_{R} are matrices of gravity vectors given by

G_{R}=[g_{R,1} g_{R,2} . . . g_{R,N}],

G_{H}=[g_{H,1} g_{H,2} . . . g_{H,N}]. (20)

The gravity vectors are measured during periods where the head is stationary. Equation (19) may be solved for the matrix product S_{H,lin}R. Similarly, sensed magnetic field vectors may be used, alone or in combination with other signals, to determine orientation, as discussed below.

The acceleration at the head mounted sensor may be written as

s_{H}=S_{H,lin}R[a−K(r_{RH})\dot{ω}+P(r_{RH})γ(ω)], (22)

where a is the acceleration vector at the reference sensor. Since the rotation vectors are known (from the head mounted sensor and/or the reference sensor) equation (22) may be solved in the processing module to estimate the position vector r_{RH} of the head mounted sensor relative to the reference sensor. Additionally, if the position center of the head is known relative to the reference sensor on the helmet, the position of the head mounted sensor may be found relative to center of the head.

The orientation can be found from the rotational components. If the linear and rotation sensing elements are in a known alignment with one another, the orientation of the linear sensing elements can also be found. Once the orientation is known, either predetermined or measured, the sensitivity and positions of the linear elements can be found. The output from a sensing element is related to the rigid body motion {a,\dot{ω},ω} by

sᵢ=gᵢ⁻¹ηᵢ^{T}[a+K(\dot{ω})rᵢ+K²(ω)rᵢ], (23)

where ηᵢ^{T} is the orientation and gᵢ⁻¹ is the sensitivity. In matrix format, the relationship may be written as

$$[ {s}_{i} - {η}_{i}^{T} \{ K ( \dot{ω} ) + {K}^{2} ( ω ) \} ] [ \begin{matrix}{g}_{i} \\ {r}_{i}\end{matrix} ] = {η}_{i}^{T} a . \qquad ( 24 )$$

An ensemble averaging over a number of sample points provides as estimate of the inverse sensitivity of the sensing element and the position of the sensing element as

$$[ \begin{matrix}{g}_{i} \\ r\end{matrix} ] = {〈 {A}^{T} A 〉}^{- 1} 〈 {A}^{T} {η}_{i}^{T} a 〉 , \qquad ( 25 )$$

where the matrix A is given by

A=[sᵢ−ηᵢ^{T}{K(\dot{ω})+K²(ω)}]. (26)

Thus, the position and sensitivity of the sensing element may be determined from the sensor output sᵢ and the measured rotation, once the orientation is known.

The sensor orientation may be determined (a) by assumption (b) from gravity measurements (c) from rotation measurement and/or (d) from rigid body motion measurements, for example. Once the orientation is known, the sensitivity and position may be determined from equations (25) and (26) above.

If several sensing elements are positioned at the same location, their positions may be estimated jointly. Equation (24) can be modified as

$$[ \begin{matrix}{s}_{1} & 0 & 0 & - {η}_{1}^{T} \{ K ( \dot{ω} ) + {K}^{2} ( ω ) \} \\ 0 & {s}_{2} & 0 & - {η}_{2}^{T} \{ K ( \dot{ω} ) + {K}^{2} ( ω ) \} \\ 0 & 0 & {s}_{3} & - {η}_{3}^{T} \{ K ( \dot{ω} ) + {K}^{2} ( ω ) \}\end{matrix} ] [ \begin{matrix}{g}_{1} \\ {g}_{2} \\ {g}_{3} \\ r\end{matrix} ] = [ \begin{matrix}{η}_{1}^{T} a \\ {η}_{2}^{T} a \\ {η}_{3}^{T} a\end{matrix} ] , \qquad ( 27 )$$

or, in matrix form,

$$[ diag ( s ) - U \{ K ( \dot{ω} ) + {K}^{2} ( ω ) \} ] [ \begin{matrix}g \\ r\end{matrix} ] = Ua \\ where \\ U = [ \begin{matrix}{η}_{1}^{T} \\ {η}_{2}^{T} \\ {η}_{3}^{T}\end{matrix} ] . \qquad ( 28 )$$

Once calibrated, the acceleration at the origin (the center of the head for example) may be found using

a=[S_{H,lin}R]⁻¹s_{H}+K(r_{H})\dot{ω}−P(r_{H})γ(ω), (29)

where r_{H} is the position of the head mounted sensor relative to the origin. This computation uses the inverse of the matrix product S_{H,lin} R, so separation of the two matrices, while possible, is not required.

Thus, a reference sensor on the mounted on a reference structure, such as a helmet or mouthguard, may be used to determine the orientation and position of the head mounted sensor, together with its sensitivity. This is important for practical applications, such as monitoring head impacts during sports games or for military personnel, where accurate positioning of a head mounted sensor is impractical, and calibration of the head mounted sensors may be expensive.

The helmet 704 may support one or more visual indicators such as light emitting diodes (LEDs) 706 or different colors. These indicators may be used to show the system state. States could include, for example, ‘power on’, ‘head sensors found’, ‘calibrating’, ‘calibration complete’ and ‘impact detected’. In one embodiment, an impact above a threshold is indicated by a flashing red light, with the level of the impact indicated by the speed of flashing.

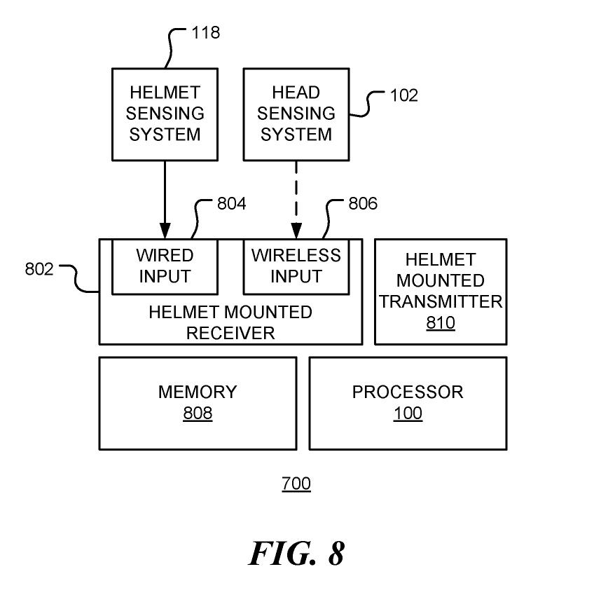

FIG. 8 is a further diagrammatic representation of the system 700 for monitoring head motion in accordance with certain embodiments of the invention. Referring to FIG. 8, the system 700 comprises a helmet motion sensing system 118, such a six degree-of-freedom sensor or a sensor array, operable to produce a first signal in response to motion of a helmet worn on the head, a receiver 802. The receiver 802 comprising a first input 804 operable to receive the first signal and a second input 806 operable to receive a second signal produced by a head motion sensing system 102 in response to motion of the head. The head motion sensing system 102 may comprise a six degree-of-freedom sensor or an array of sensors. In one embodiment, the first input comprises a wired input and the second input comprises a wireless input. The system also includes a processor 100, either mounted in the helmet or at a remote location, which is operable to process the first and second signals to calibrate the head motion sensing system relative to the helmet motion sensing system and to process the second signals to determine head motion. The system may include a memory 808 for storing a description of the head motion or for storing the first and second signals, and a transmitter for transmitting a description of the head motion, and/or the first and second signals, to remote location. The transmitted signal may include an identifier that may be used to identify the helmet, and thus the wearer. While FIG. 8 refers to a helmet, an alternative reference structure, such as a mouthguard, may be used.

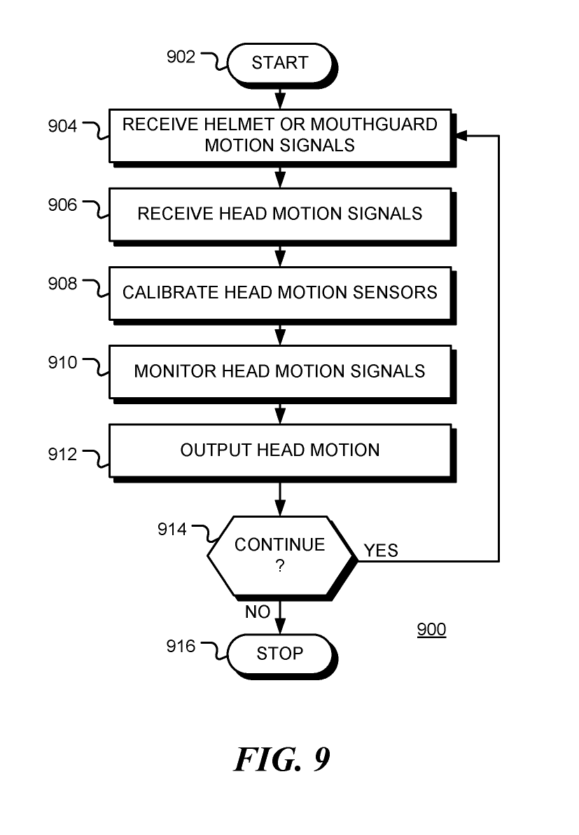

FIG. 9 is a flow chart 900 of method for monitoring rigid body motion using self-calibration, in accordance with certain embodiments of the invention. Following start block 902 in FIG. 9, reference motion signals are received at block 904 (from motion sensors on a helmet, mouthguard or other reference structure) and head motion signals are received at block 906 from head motion sensors. At block 908, the reference and head motion signals are processed to calibrate the head motion sensors relative to the reference structure motion sensors. The calibration parameters, such as sensor sensitivity, orientation and position, may be stored in a memory. At block 910, the head motion signals are monitored and combined with the calibration parameters to determine motion of the head. A description of the head motion is then output, at block 912, to a local memory to a remote location. If continued operation is required, as depicted by the positive branch from decision block 914, flow continues to block 904 to update the calibration parameters, or flow continues to block 910 to monitor head motion signals. Otherwise, the method terminates at block 916.

In one embodiment, the head motion is only calculated or output when motion is above a threshold level and calibration is only performed when the motion is below a threshold.

### Helmet Performance

The performance of a protective body, such as a military, sports or motorcycle helmet, or a shipping container, may be determined by comparing the motion of the protective body (e.g. the helmet or container) with the motion of the protected body (e.g. the head or shipped item). For example, linear and rotational accelerations may be compared. If the acceleration of the protected body is much lower than that of the protective body, the performance is good. If the acceleration of the protected body is similar to that of the protective body, the performance is poor.

The signal from a linear accelerometer is a combination of linear and rotational motion, as described in equation (1), and is dependent upon the chosen origin. In order to compare signals from a head accelerometer and a helmet accelerometer, the sensors should be referenced to a common frame of reference, including a common origin. This requires knowledge of their relative positions and orientations. However, the magnitude (not direction) of the signals can be compared if the relative positions are known. The signals from rotational sensor may be compared if their relative orientations are known. However, the magnitude of rotational motion may be compared directly.

In one embodiment performance of a helmet on a head is monitored by determining linear motion of the head relative to a common origin in response to sensed head motion, determining linear motion of the helmet relative to the common origin in response to sensed helmet motion, and comparing the determined linear motion of the head with the determined linear motion of the helmet to provide a measure of the performance of the helmet. The linear motion of the head relative to the common origin is determined by receiving first sensor signals from a head-mounted sensor, receiving second first sensor signals from a helmet-mounted sensor, determining a location of the head-mounted sensor in response to the first and second signals, and determining linear motion of the head relative to the common origin dependent upon sensed linear motion of the head, sensed rotational motion of the head and the determined location of the head-mounted sensor. Optionally, motion directions of the head and helmet may be compared in a common frame of reference by determining an orientation of the head-mounted sensor with respect to a common frame of reference in response to the first and second signals, determining linear motion of the head relative to a common frame of reference in response to the sensed head motion, determining linear motion of the helmet relative to the common frame of reference in response to the sensed helmet motion, and comparing the linear head motion in the common frame of reference with the linear helmet motion in the common frame of reference to determine performance of the helmet.

Rotational motions may also be compared by determining rotational motion of the head in response to the sensed head motion, determining rotational motion of the helmet in response to the sensed helmet motion, and comparing the rotational head motion with the linear helmet motion to determine performance of the helmet. The determined linear motion of the head, the determined rotational motion of the head, the determined linear motion of the helmet and the determined rotational motion of the helmet may have a common frame of reference.

The location and orientation of the head-mounted sensor may be found in response to the first second signals received from a head-mounted sensor and second sensor signals received from a helmet-mounted sensor. In addition, one or more sensitivities of the head-mounted sensor may be determined in response to the first and second sensor signals.

In one embodiment, performance of a helmet on a head is monitored by determining head motion relative to a common frame of reference in response to sensed motion of the head, determining helmet motion relative to the common frame of reference in response to sensed motion of the head, and comparing the head motion in the common frame of reference with the helmet motion in the common frame of reference to determine performance of the helmet. Determining motion in a common frame of reference from a sensor measurement uses knowledge of the position and orientation of the sensor in the common frame of reference.

The common frame of reference may be a helmet frame of reference, in which case determining the head and helmet motions relative to the common frame of reference comprises transforming sensed head and helmet motions to the helmet frame of reference. The location, orientation and sensitivity of the one or more helmet sensors may be predetermined, while the location, orientation and sensitivity of the one or more head sensors may be determined (as described above, for example) from measurements at lower acceleration levels, where the helmet motion is substantially the same as the head motion.

The common frame of reference may be a frame of reference of one or more helmet-mounted sensors, in which case determining head motion relative to the common frame of reference comprises transforming sensed head motion to the frame of reference of the one or more helmet-mounted sensors.

Head motion relative to the common frame of reference may be found by determining head rotational motion from one or more head-mounted sensors, determining helmet rotational motion from one or more helmet-mounted sensors, and determining an orientation of the one or more head-mounted sensors relative to the common frame of reference from the head rotational motion and the helmet rotational motion.

Head linear motion may be found from the one or more head-mounted sensors by determining helmet linear motion from the one or more helmet-mounted sensors, and determining a position of the one or more head-mounted sensors relative to the common frame of reference from the head linear motion and the helmet linear motion.

Helmet motion relative to the common frame of reference in response to sensed helmet motion may be found by sensing helmet rotation rate using a gyroscope to provide a first estimate of rotation rate. The gyroscope offset bias may be found by sensing helmet orientation using a magnetic field sensor and a gravitational field sensor to provide a second estimate of rotation rate from the sensed helmet orientation. The bias offset may be found by comparing the first and second estimates of rotation rate. The resulting bias offset may be subtracted from the first estimate of rotation rate to provide a rotational component of the helmet motion. In one embodiment, a correction to the bias offset is found by passing the difference between the first and second estimates of rotation rate through a lowpass filter.

In one embodiment, head motion, relative to the common frame of reference and in response to sensed head motion, is found by determining linear and rotational head motion at an origin of the common frame of reference in response to linear and rotational head motion sensed by a head-mounted motion sensor at a location displaced from the origin of the common frame of reference. The location of the head-mounted motion sensor may be estimated from the sensed head motion and the sensed helmet motion, as described above.

Helmet motion, relative to the common frame of reference and in response to sensed helmet motion, is found by determining linear and rotational helmet motion at an origin of the common frame of reference in response to linear and rotational helmet motion sensed at location displaced from the origin of the common frame of reference.

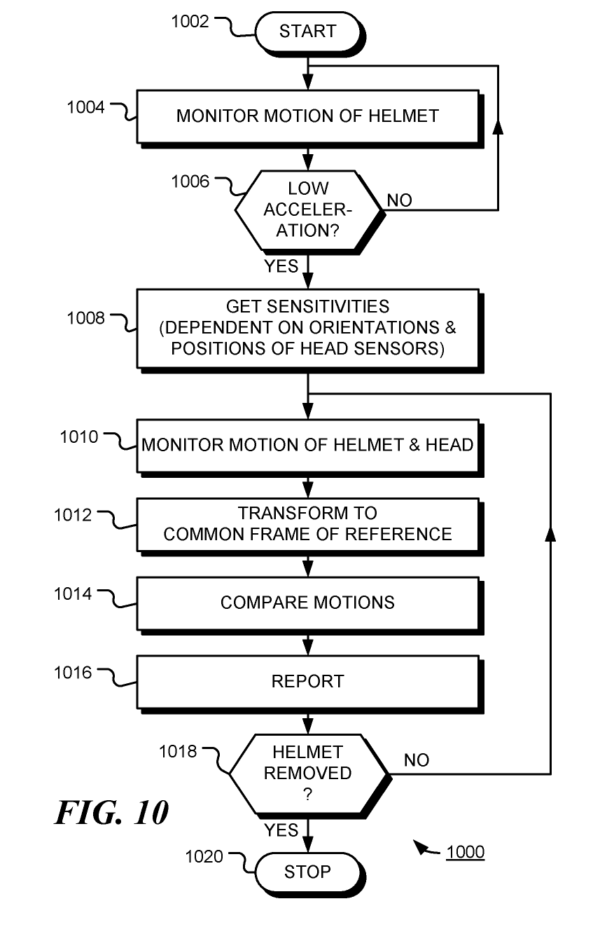

FIG. 10 is a flow chart 1000 of a method for monitoring performance of a helmet, shipping container, or other impact protective device, in accordance with certain embodiments of the invention. The method will be described with reference to a helmet, but application of the method is not limited to helmets and other applications will be apparent to those of skill in the art. The system uses one or more sensors mounted on the helmet and one or more sensors mounted on the head. The method will be described for an embodiment in which a single head sensor and a single helmet sensor are used, although it is to understood that the single sensors may contain multiple sensing elements or that multiple sensors may be used. Following start block 1002 in FIG. 10, motion of the helmet is monitored at block 1004. The start may be triggered, for example, by the head sensor being moved within range of a remote power circuit located in the helmet, as is commonly practiced for RFID tags, for example. Similarly, separation of the helmet from the head may be used to power down the system, or to start a power-down timer. After triggering, the head sensor may be powered from the remote power circuit or from a battery. Passive vibration isolation fails at low frequencies. Thus, when accelerated slowly, the helmet and head move together and the head motion can be determined from the helmet motion. This enables calibration of head mounted sensors as described above. Accordingly, at decision block 1006 a check is made to determine if the acceleration is low enough that the helmet and head move together. The check may compare the acceleration to a threshold or may consider a distribution of frequency components of the acceleration, for example. If the acceleration is too high, as depicted by the negative branch from decision block 1006, flow returns to block 1004. Otherwise, as depicted by the positive branch from decision block 1006, the head sensor is calibrated at block 1008. As described above, the calibration is dependent upon the location and orientation of the head sensor, as well as the sensitivities and offsets of individual sensing elements within the sensor. At block 1010 the helmet and head motion is monitored using the helmet and head sensors. At block 1012, the monitored helmet and head motions are transformed to a common frame of reference. Transformation of the head motion utilizes the calibration parameters determined at block 1008. The common frame of reference may be the frame of reference of the helmet, the helmet sensor, or some other frame. The sensed linear acceleration of an object rotating about an origin is dependent upon the distance of the sensor from the origin, thus in accordance with certain embodiments, the head motion and the helmet motion are reference to a common origin in the common frame of reference. In one embodiment, a measured rotation vector w, is transformed to a rotation rate vector ω and a rotational acceleration vector \dot{ω} in the common frame of reference according to

ω=F(w), \dot{ω}=G(w). (30)

This transformation depends upon the orientation of the sensor relative to the common frame of reference. A measured linear acceleration s, is transformed to a linear acceleration a in the common frame of reference according to

a=Sₗᵢₙ⁻¹s+K(r)\dot{ω}−P(r)γ(ω), (31)

As described above in equation (7) above, for example. These transformations depends upon the orientation and location (r) of the sensor relative to the common frame of reference, as well as the rotational motion. At block 1014, the head and helmet motions in the common frame of reference are compared to provide an indication of helmet performance. The helmet performance is reported at block 1016. For example, the helmet performance may be saved in a transient or non-transient computer memory, displayed on a screen, communication to a remote location or any combination thereof. At block 1018, a check is made to determine if the helmet has been removed. This may be done, for example, by monitoring a strength of a wireless communication signal between a transceiver in the helmet and a transceiver of head sensor. If the helmet has not been removed, as depicted by the negative branch from decision block 1018, flow returns to block 1010. Otherwise, the method terminates at block 1020.

The common frame of reference may be a helmet frame of reference or a frame of reference of a helmet mounted sensor. The orientation of a head mounted sensor in the frame of reference of a helmet sensor may be found by sensing orientation of both the helmet sensor and the head sensor to an Earth frame of reference (using a tilt sensor and an electronic compass, for example). However, location of the head sensor with respect to the original may also be needed.

The above method provides for in-situ monitoring of helmet performance and head impacts. The same method may be applied to a helmet mounted on a dummy head to facilitate laboratory testing of helmets, or to monitoring an item in a shipping container.

The system 700 of FIG. 7 and FIG. 8 may be used for monitoring performance of a helmet. Referring to FIG. 8, The system includes a helmet sensing system 118 configured to provide first motion signals when mounted on the helmet, a head sensing system 102 configured to provide second motion signals when mounted on a head of a wearer of the helmet and a processor 100. The sensing systems may include accelerometers, gyroscopes, magnetic field sensors and the like. The first and second motion signals are received by receiver 802 and passed to the processor 100, which may be local or remote to the helmet. The processor 100 is operable to determine helmet motion in a common frame of reference in response to the first motion signals, determine head motion in the common frame of reference in response to the second motion signals, and compare the head motion in the common frame of reference with the helmet motion in the common frame of reference to determine the helmet performance. The resulting helmet performance is output for display, analysis and/or storage (in memory 808, for example).

The processor may be further operable to determine an orientation of the second motion sensor dependent upon the first and second motion signals or to determine a location of the second motion sensor dependent upon the first and second motion signals. The helmet sensing system and the processor may be located in a common housing. The first and second motion signals may be synchronized in time.

FIG. 11 is a view of a head-mountable sensor patch in accordance with exemplary embodiments. The sensor patch 102 comprises a flexible mounting structure 604 having a concave edge 608, a battery 1106 with connection terminal 1108, and a cavity 1120 with opening 1112. A sensing circuit 602 is configured for insertion into the cavity 1120 through opening 1112. When inserted, a connection pads, such as 1118, of the sensing circuit make electrical contact with connection terminals, such as 1108, to provide electrical power to the sensing circuit 602. When the sensing circuit 602 is inserted into the cavity 1120, a tab 1114 coupled to the sensing circuit remains outside of the cavity and may be grasped by a user to facilitate insertion and removal of the sensing circuit. An antenna 1122 for wireless communication with the sensing circuit may be embedded in or deposited on the tab 1114.

In one embodiment, the power source comprises a resonant electromagnetic circuit adapted to receive power from a remote source.

A view through the section 12-12 is shown in FIG. 12.

FIG. 12 is a sectional view through the section 12-12 of the exemplary patch sensor shown in FIG. 11, in accordance with certain embodiments. The sensor 102 includes a flexible mounting structure 604, an adhesive sub-layer 1102, and a removable protective layer 1104. Removal of the protective layer 1104, by peeling for example, exposes the adhesive layer and enables the patch sensor to be attached to a surface, such as the skin of a user. A battery 1106 within the mounting structure 604 has electrical terminals 1108 and 1110. A sensing circuit 602 has corresponding electrical connectors 1116 and 1118 arranged to make electrical contact with the battery terminals 1108 and 1110 when the sensing circuit is inserted into a cavity 1120 of the mounting structure through opening 1112. The tab 1114, coupled to the sensing circuit 602, facilitates insertion and removal of the sensing circuit and may include a printed or embedded antenna to enable wireless communication with the sensing circuit 602.

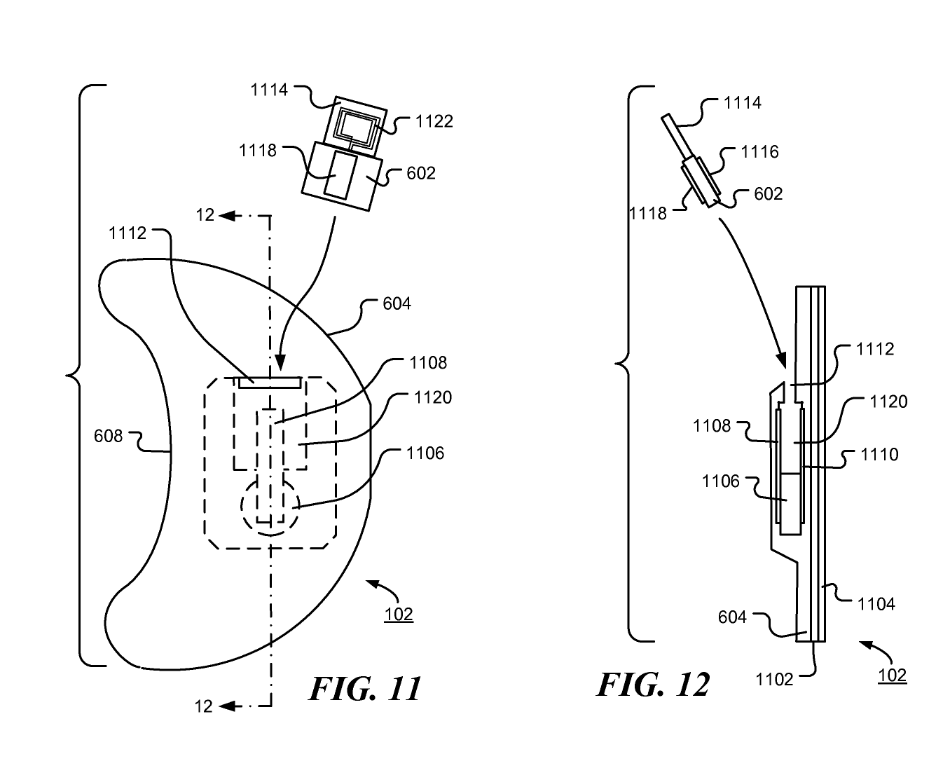

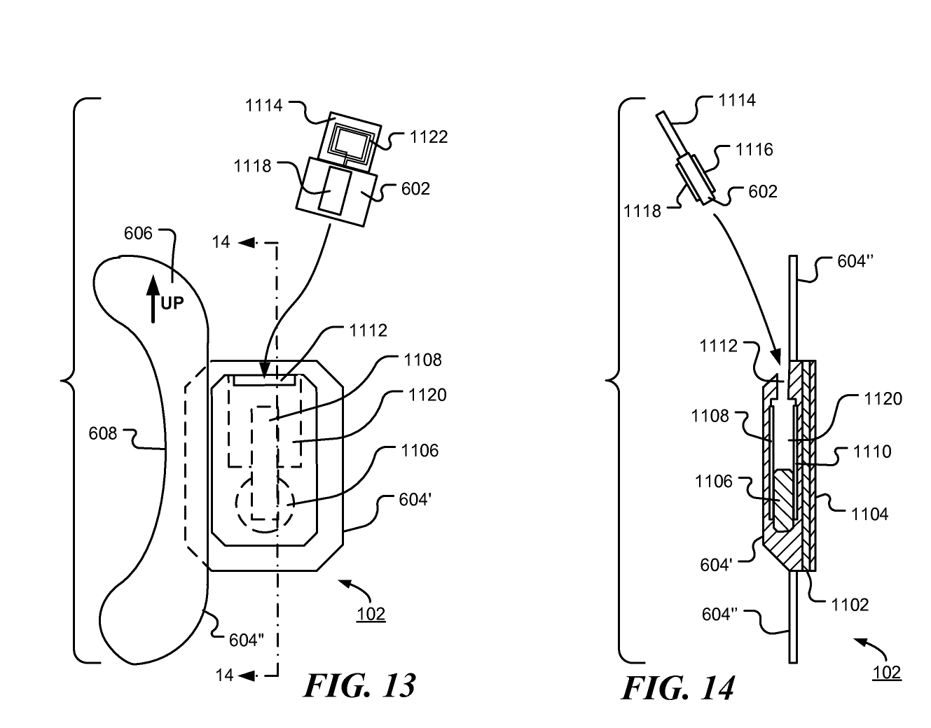

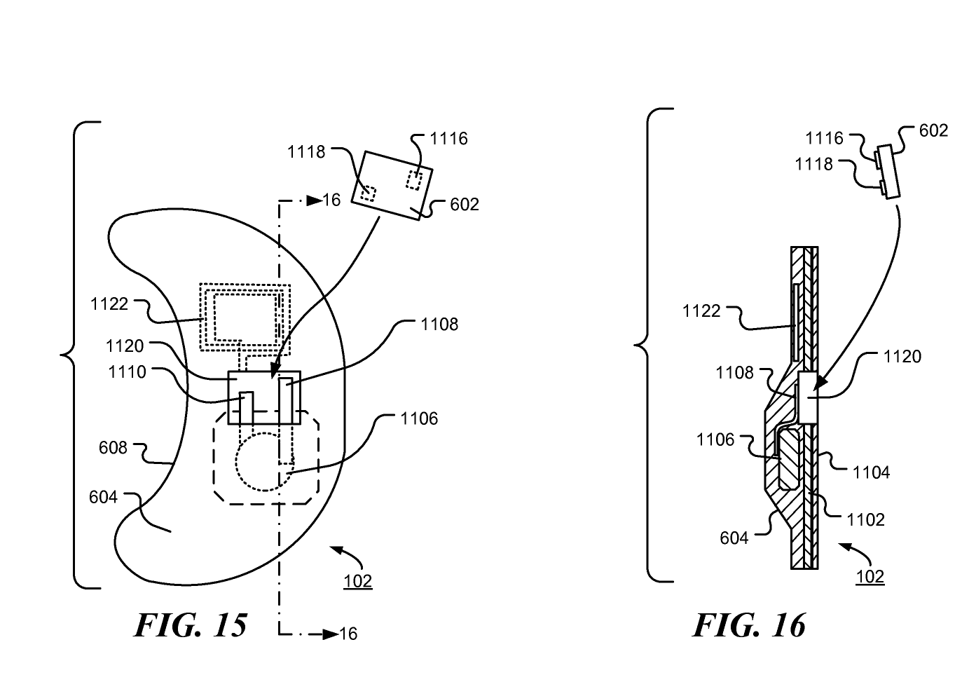

An advantage of the embodiment shown in FIG. 11 and FIG. 12 is that the mounting structure may be easily replaced. The mounting structure includes the components, such as the battery and the adhesive layer, that have relatively short useable life, whereas the sensing circuit 602 may be used repeatedly. This approach is less expensive than replacing the complete sensor, and is more convenient than having to separately replace batteries and adhesive layers. Further, reliability is increased by using a fresh battery each time the sensor is used. In the embodiment of a sensor patch 102 shown in FIGS. 13 and 14, the mounting structure has a first part 604′, configured to couple the sensing circuit 602 to a surface to be monitored, and a second part 604″. The second part 604″ is a removable template that enables accurate positioning and orientation of the sensor on a head by aligning a concave edge 608 with the back of an ear. In the embodiment shown, the sensor is configured for placement behind a left ear, as indicated by the marking 606 in FIG. 13. The section 14-14 is shown in FIG. 14. Before attachment to the head, the sensing circuit 602 is inserted into cavity 1120 and the protective covering 1104 is removed to expose the layer of adhesive 1102. After attachment to the head, the template 604″ may be removed to improve comfort. After removal from the head, the sensing circuit 602 may be removed from the cavity 1120 by pulling on the exposed tab 1114. The removed sensing circuit may be reused in a new mounting structure.

Alternative embodiments may use re-chargeable batteries coupled to the sensing circuit or a circuit configured to receive power from a remote source, using resonant electromagnetic coupling for example. In the embodiment shown in FIG's 15 and 16, the cavity 1120 in the mounting structure 604 opens to the underside of the sensor patch 102. Connection pads 1116 and 1118 on the top of sensing circuit 602 electrically couple to the terminals 1108 and 1110 of battery 1106 when the sensing circuit is inserted into the cavity 1120. In this embodiment, an antenna 1122 is embedded in or coupled to the mounting structure 604 to enable wireless communication, wireless power reception or both.

The exemplary embodiments described above provide a sensor 102 that may be used for monitoring motion of a body. The sensor includes a flexible mounting structure 604 having a cavity 1120 and an underside 1102 configured to enable coupling to the body. The sensor also includes a power source, such as battery 1106, and a motion sensing circuit 602 sized to be easily inserted into and removed from the cavity 1120 of the mounting structure 604 through an opening 1112 in the flexible structure. The motion sensing circuit 602 is adapted to receive power from the power source and provides motion signals in response to motion of the body to which it is coupled.

The sensor 102 may include a removable template 604″, as shown in FIG. 6C or FIG. 13, which overlays the flexible mounting structure. The template may be shaped, at least in part, to facilitate alignment of the sensor with a characteristic feature of the body. In the embodiment of FIG. 6C, an edge 608 of the template is shape to allow alignment with the ear of the user.

The sensor may also include a wireless communication circuit that is physically coupled to the motion sensing circuit 602 and includes an antenna 1122 that extends from the cavity 1120 of the flexible mounting structure when the motion sensor circuit is inserted into the cavity of the mounting structure. Battery 1106 may be omitted when wireless power is provided.

Various other configurations which allow for reuse of the sensing circuit will be apparent of those of ordinary skill in the art. For example, the adhesive layer 1102 may be replaced with double-side tape.

Some aspects and features of the disclosed sensor are set out in the following numbered items.

1. A sensor for monitoring motion of a body, comprising:
a flexible mounting structure having a cavity and an underside configured to enable coupling to the body;
a power source; and
a motion sensing circuit sized to be inserted into and removed from the cavity of the mounting structure through an opening in the flexible structure and adapted to receive power from the power source, the motion sensing circuit providing motion signals in response to motion of the body.
   2. The sensor of item 1, further comprising a removable template that overlays the flexible mounting structure, the template shaped, at least in part, to facilitate alignment of the sensor with a characteristic feature of the body.
   3. The sensor of item 2, where the body comprises a head and where the characteristic feature comprises an ear or a nose.
   4. The sensor of item 1, further comprising a wireless communication circuit that is physically coupled to the motion sensing circuit and includes an antenna that extends from the cavity of the flexible mounting structure when the motion sensor circuit is inserted into the cavity of the mounting structure.
   5. The sensor of item 1, where the flexible mounting structure further comprises an antenna operable to couple to a wireless communication circuit of the motion sensing circuit when the motion sensor circuit is inserted into the cavity of the mounting structure.
   6. The sensor of item 1, where the power source comprises a battery in the mounting structure.
   7. The sensor of item 1, where the power source comprises a resonant electromagnetic circuit adapted to receive power from a remote source.
   8. The sensor of item 1, where the motion sensing circuit includes an accelerometer and a rotation sensor.
   9. The sensor of item 8, where the motion sensing circuit further includes an electronic compass.
   10. A system for monitoring performance of a helmet, comprising:
a helmet motion sensor configured to provide first motion signals when mounted on the helmet;
the sensor of item 1, configured to provide second motion signals when mounted on a head of a wearer of the helmet; and
a processor operable to:
   determine helmet motion in a common frame of reference in response to the first motion signals;
   determine head motion in the common frame of reference in response to the second motion signals;
   compare the head motion in the common frame of reference with the helmet motion in the common frame of reference to determine the helmet performance; and
   output the helmet performance.

### Gyroscope Bias Compensation

Rotation rate sensors, such as gyroscopes, often have a bias offset. In the descriptions above it is assumed that the bias offsets have been removed. In accordance with one embodiment of the disclosure, the bias offsets may be remove by use of a magnetic field sensor (electronic compass) and accelerometer (gravitational filed sensor) in a known orientation to the gyroscope.

When dynamic acceleration is small, the absolute orientation of the sensor relative to the Earth can be found from the magnetic field vector m and the acceleration vector g. The rotation can denoted by the rotation matrix

R(t)=[nwu]^{T}, (32)

where the vectors are calculated as, for example,

$$u = g / \vert g \vert , w = \frac{u \times m}{\vert u \times m \vert} , and n = u \times w . \qquad ( 33 )$$

The rotation rate matrix is related to the rotation matrix R and its time derivative \dot{R} as

$${Ω}_{c} {=}^{Δ} [ \begin{matrix}0 & - {ω}_{3} & {ω}_{2} \\ {ω}_{3} & 0 & - {ω}_{1} \\ - {ω}_{2} & {ω}_{1} & 0\end{matrix} ] = {R}^{t} \dot{R} , \qquad ( 34 )$$

so the rotation rate vector may be calculated as, for example,

$${ω}_{c} = \frac{1}{2} [ \begin{matrix}{Ω}_{32} - {Ω}_{23} \\ {Ω}_{13} - {Ω}_{31} \\ {Ω}_{21} - {Ω}_{12}\end{matrix} ] . \qquad ( 35 )$$

This estimate of the rotation rate is generally noisy, due in part to stray magnetic fields. The raw gyroscope signal ω_{g}(n) at sample n is less noisy but has a variable bias offset. The vector of offsets, c(n), can be updated according to, for example

c(n)=(1−μ)c(n−1)+μL(q⁻¹)(ω_{g}(n)−ω_{c}(n)), (36)

where q⁻¹ is the delay operator, L(q⁻¹) denotes a lowpass filter and μ is an update step size (which may be reduced when dynamic acceleration is detected). The corrected rotation rate may be computed as

\hat{ω}(n)=ω_{g}(n)−c(n). (36)

This, in accordance with certain aspects of the disclosure, a gyroscope bias is removed by:
a) receiving a first rotation rate ω_{g}(n) from a gyroscope;
b) determining a second rotation rate ω_{c}(n) by differentiating an orientation signal with respect time;
c) filtering a difference between the first and second rotation rates to obtain a low frequency difference L(q⁻¹)(ω_{g}(n)−ω_{c}(n));
d) updating a bias offset c(n) dependent upon the filtered difference (as in equation (36), for example); and
e) subtracting the updated bias offset from the first rotation rate to obtain a bias-correct rotation rate \hat{ω}(n)=ω_{g}(n)−c(n).

Other techniques for using an electronic compass and tilt sensor to determine absolute gyroscope bias offset will be apparent to those of ordinary skill in the art. For example, time periods during which there is no rotation may be detected to enable direct measurement of the offset vector.

The rotation rate vector may be integrated to obtain a dynamic estimate of head or helmet orientation. Such integration is subject to drift due integration of random noise and imperfect offset removal. The drift may be compensated for by using an electronic compass and tilt sensor. Compensation techniques are well known to those of skill in the art. Head and helmet orientations may be reported to enable graphical display of an impact. Further, head or helmet orientations, or both, and acceleration directions from different players may be combined to create, display or analyze a model of an impact between two or more players. The players may be identified by finding impacts that occur at the same time.

In one embodiment, sampling of the signals from head and helmet sensors is synchronized by transmitting a common timing signal to sampling circuits of both sensors. The timing signals may originate at one of the sensors or at a remote device.

One application of the disclosure relates to a method for monitoring performance of a shipping container in protecting a shipped item within the container from impacts. Motion of the shipped item is determined relative to a common frame of reference in response to sensed motion of the shipped item, and motion of the shipping container is sensed relative to the common frame of reference in response to sensed motion of the shipping container. The motion of the shipped item in the common frame of reference is compared with the motion of the shipping container in the common frame of reference to determine performance of the shipping container. The common frame of reference may be an Earth frame, a frame of the shipping container, or a frame of a motion sensor mounted on the shipping container.

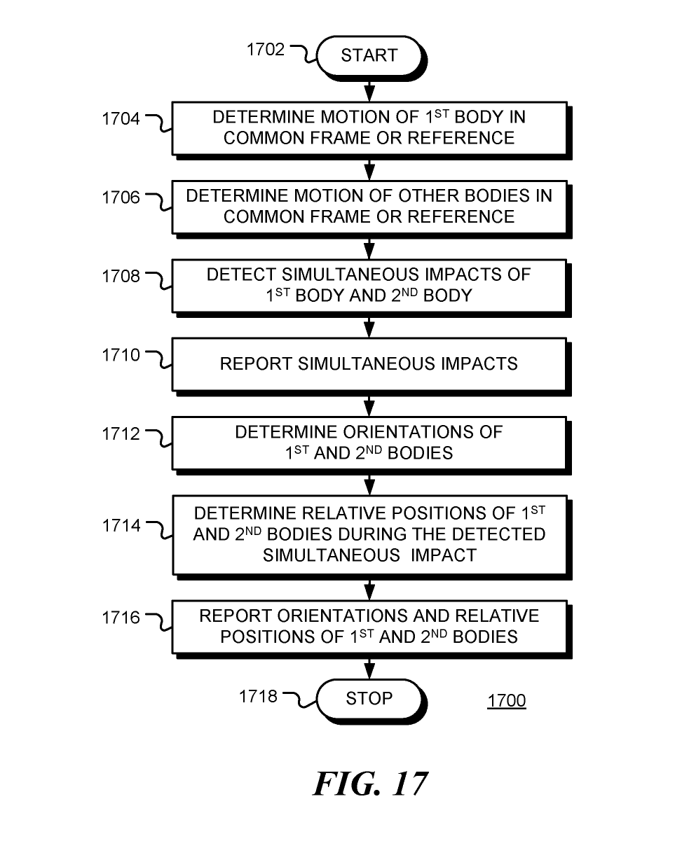

In a further embodiment, the systems and methods described above may be used to monitor impacts between bodies. The bodies may be head or helmets of players on opposing sports teams for example. Impact motion of the first body relative to a common frame of reference is determined in response to sensed motion of the first body, and impact motion of the second body relative to the common frame of reference is determined in response to sensed motion of the second body. Simultaneous impact motion of the first and second bodies from the impact motions of the first and second bodies is detected so as to identify which players are involved in the impact. Finally, the simultaneous impact motions of the first and second bodies are compared. In addition, the orientations of the first and second bodies, relative to the common frame of reference, may be determined from rotation rate signals or orientation signals. This enables the relative positions of the first and second bodies during the detected simultaneous impact motion to be determined and facilitates analysis, display and reporting of the impact. The positions may be found, for example, by determining the linear accelerations of the two bodies (using equation (7) for example, with sensed linear and rotational motions), in a common frame of reference, relative to an origin, such as the approximate center of mass of each body, and aligning the linear acceleration vectors of the two bodies. FIG. 17 is a flow chart 1700 of a method for monitoring impacts between a first body and a second body. Following start block 1702, impact motion of the first body is determined, at block 1704, relative to a common frame of reference and in response to sensed motion of the first body. At block 1706, impact motion of one or more other bodies is detected, relative to the common frame of reference and in response to sensed motion of the second body. At block 1708, impact motions of the first body is compared with impact motions of the other body and a second body having simultaneous impact motion with the first body is detected. The simultaneous impact motions of the first and second bodies are reported, together with an identification of the second body. For example, in a sports application, impacts to the helmet or head of one player are compared with impacts to other players. If substantially simultaneous impacts are detected, it is determined that an impact has occurred between the two players. Sensed motion may then be reported and analyzed, at block 1710, to characterize the impact. Optionally, at block 1712, the orientations of the first body and the identified second body (in a common frame of reference such as the Earth frame) may be determined from sensed gravity and magnetic field signals. From the orientations and the sensed direction of impact, the relative positions of the first and second bodies at the time of impact may be determined at block 1714 and reported at block 1716. The process terminates at block 1718.

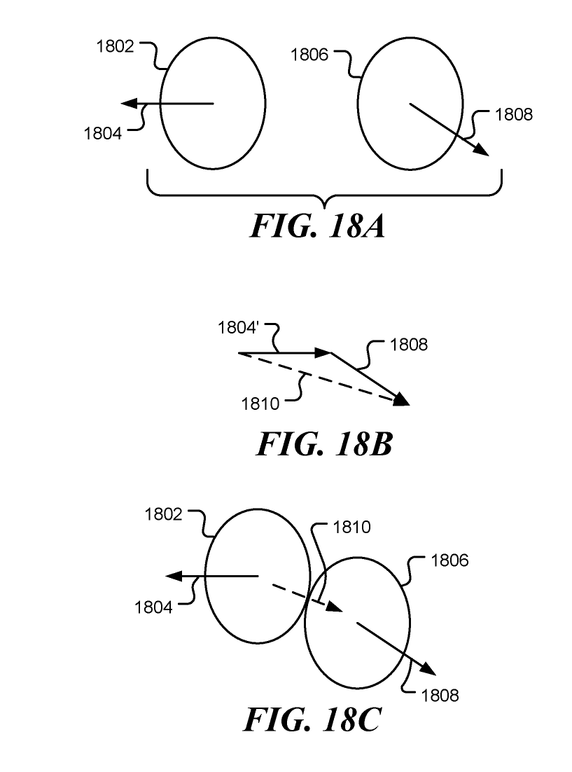

FIG. 18A, FIG. 18B and FIG. 18C illustrate an exemplary method for determining relative positions of the first and second bodies at the time of impact. FIG. 18A shows a first body 1802 (such as a first helmet or head) having an impact acceleration shown by the vector 1804 and a second body 1806 having an impact acceleration shown by the vector 1808. The vectors are shown in a common frame of reference, such as an Earth frame of reference. The vectors 1804 and 1808 may have substantially opposite directions. FIG. 18B shows an exemplary method of combining the acceleration vectors 1804 and 1808. In this example vector 1810 is obtained as the difference between the vectors 1808 and 1804 (note: 1804′ is in the opposite direction to 1804). Only the direction of vector 1810 is to be used. The relative positions of the bodies are found by aligning points on the bodies at which the vector 1810 is normal to the surface of the body, as shown in FIG. 18C. Other methods for combining the vectors 1804 and 1808 may be used.

In an embodiment where the first and second bodies are helmets, head motion may also be monitored during the detected simultaneous impact to enable helmet performance to be monitored, as described above.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of the invention.

What is claimed is:

1. A method for monitoring performance of a helmet on a head, comprising:
determining head motion relative to a common frame of reference in response to sensed motion of the head;
determining helmet motion relative to the common frame of reference in response to sensed motion of the helmet; and
comparing the head motion in the common frame of reference with the helmet motion in the common frame of reference to determine performance of the helmet.

2. The method of claim 1, where the common frame of reference comprises a helmet frame of reference, and where determining the head motion relative to the common frame of reference comprises:
sensing head motion using a head-mounted sensor; and
transforming the sensed head motion from a frame of reference of the head-mounted sensor to the helmet frame of reference;
and where determining helmet motion relative to the common frame of reference comprises:
sensing helmet motion using a helmet-mounted sensor; and
transforming the sensed helmet motion from a frame of reference of the helmet-mounted sensor to the helmet frame of reference.

3. The method of claim 1, where the common frame of reference comprises a frame of reference of one or more helmet-mounted sensors, and where determining head motion relative to the common frame of reference comprises transforming sensed head motion from a frame of reference of a head-mounted sensor to the frame of reference of the one or more helmet-mounted sensors.

4. The method of claim 1, where determining head motion relative to the common frame of reference comprises:
determining head rotational motion from one or more head-mounted sensors;
determining helmet rotational motion from one or more helmet-mounted sensors; and
determining an orientation of the one or more head-mounted sensors relative to the common frame of reference from the head rotational motion and the helmet rotational motion.

5. The method of claim 4, further comprising:
determining head linear motion from the one or more head-mounted sensors;
determining helmet linear motion from the one or more helmet-mounted sensors; and
determining a position of the one or more head-mounted sensors relative to the common frame of reference from the head linear motion and the helmet linear motion.

6. The method of claim 1, where determining helmet motion relative to the common frame of reference in response to sensed helmet motion comprises:
sensing helmet rotation rate using a gyroscope to provide a first estimate of rotation rate;
sensing helmet orientation using a magnetic field sensor and a gravitational field sensor;
determining a second estimate of rotation rate from the sensed helmet orientation;
determining a gyroscope bias offset in response to the first and second estimates of rotation rate; and
subtracting the gyroscope bias offset from the first estimate of rotation rate to provide a rotational component of the helmet motion.

7. The method of claim 1, where determining head motion relative to the common frame of reference in response to sensed head motion comprises:
determining linear and rotational head motion at an origin of the common frame of reference in response to linear and rotational head motion sensed by a head-mounted motion sensor at a location displaced from the origin of the common frame of reference.

8. The method of claim 7, further comprising determining a location of the head-mounted motion sensor in response to the sensed head motion and the sensed helmet motion.

9. The method of claim 1, where determining helmet motion relative to the common frame of reference in response to sensed helmet motion comprises:
determining linear and rotational helmet motion at an origin of the common frame of reference in response to linear and rotational helmet motion sensed at a location displaced from the origin of the common frame of reference.

10. A method for monitoring impacts between a first body and a second body, comprising:
determining impact motion of the first body relative to a common frame of reference in response to sensed motion of the first body;
determining impact motion of the second body relative to the common frame of reference in response to sensed motion of the second body;
detecting simultaneous impact motion of the first and second bodies from the impact motions of the first and second bodies; and
reporting the simultaneous impact motion of the first and second bodies.

11. The method of claim 10, further comprising:
determining orientation of the first body relative to the common frame of reference;
determining orientation of the second body relative to the common frame of reference; and
determining relative positions of the first and second bodies during the detected simultaneous impact motion.

12. The method of claim 10, where the first body comprises a head and the second body comprises a head.

13. The method of claim 10, where the first body comprises a helmet and the second body comprises a helmet.

14. The method of claim 10, where the first body comprises a head and the second body comprises a helmet.

15. The method of claim 10, where the common frame of reference comprises a frame of reference of the Earth.

16. A method for monitoring performance of a helmet on a head, comprising:
determining linear motion of the head relative to a common origin in response to sensed head motion;
determining linear motion of the helmet relative to the common origin in response to sensed helmet motion; and
comparing the determined linear motion of the head with the determined linear motion of the helmet to provide a measure of the performance of the helmet.

17. The method of claim 16, where determining linear motion of the head relative to the common origin comprises:
receiving first sensor signals from a head-mounted sensor;
receiving second first sensor signals from a helmet-mounted sensor;
determining a location of the head-mounted sensor in response to the first and second sensor signals; and
determining linear motion of the head relative to the common origin dependent upon sensed linear motion of the head, sensed rotational motion of the head and the determined location of the head-mounted sensor.

18. The method of claim 16, where determining linear motion of the head relative to the common origin further comprises:
determining an orientation of the head-mounted sensor with respect to a common frame of reference in response to the first and second sensor signals; and
determining linear motion of the head relative to a common frame of reference in response to the sensed head motion;
the method further comprising:
determining linear motion of the helmet relative to the common frame of reference in response to the sensed helmet motion; and
comparing the linear head motion in the common frame of reference with the linear helmet motion in the common frame of reference to determine performance of the helmet.

19. The method of claim 16, further comprising:
determining rotational motion of the head in response to the sensed head motion;
determining rotational motion of the helmet in response to the sensed helmet motion; and
comparing the rotational head motion with the linear helmet motion to determine performance of the helmet.

20. The method of claim 16, where the determined linear motion of the head, the determined rotational motion of the head, the determined linear motion of the helmet and the determined rotational motion of the helmet have a common frame of reference.

21. The method of claim 20, further comprising:
receiving first sensor signals from a head-mounted sensor;
receiving second first sensor signals from a helmet-mounted sensor; and
determining a location and an orientation of the head-mounted sensor in response to the first and second sensor signals.

22. The method of claim 21, further comprising:
determining one or more sensitivities of the head-mounted sensor in response to the first and second sensor signals.

23. A system for monitoring performance of a helmet, comprising:
a helmet sensing system configured to provide first motion signals when mounted on the helmet;
a head sensing system configured to provide second motion signals when mounted on a head of a wearer of the helmet; and
a processor operable to:
determine helmet motion in a common frame of reference in response to the first motion signals;
determine head motion in the common frame of reference in response to the second motion signals;
compare the head motion in the common frame of reference with the helmet motion in the common frame of reference to determine the helmet performance; and
output the helmet performance.

24. The system of claim 23, where the processor is further operable to determine an orientation of the head sensing system dependent upon the first and second motion signals.

25. The system of claim 23, where the processor is further operable to determine a location of the head sensing system dependent upon the first and second motion signals.

26. The system of claim 23, where the first and second motion signals are synchronized in time.

27. The system of claim 23, where the helmet sensing system and the processor are located in a common housing.

28. The system of claim 23, where at least one of the helmet sensing system and the head sensing system is operable to communicate with the processor over a wireless communication link.

29. The system of claim 23, where the helmet sensing system includes one or more of: an accelerometer, a gyroscope and a magnetic field sensor.

30. The system of claim 23, where the first and second motion signals are synchronized in time.
